(19) United States
(12) Patent Application Publication
(10) Pub. No.: US 2017/0056916 A1
(43) Pub. Date: Mar. 2, 2017

(54) SILICON BALL IN A GLASS TUBE ADVANCED BY THREADED ROD DISPENSING MICRO AMOUNTS OF OILS OR OTHER MATERIALS

(71) Applicant: Malic Bedford, San Diego, CA (US)

(72) Inventor: Malic Bedford, San Diego, CA (US)

(21) Appl. No.: 15/242,822

(22) Filed: Aug. 22, 2016

Related U.S. Application Data
(60) Provisional application No. 62/211,744, filed on Aug. 29, 2015.

(51) Int. Cl. B05C 17/01; B05C 17/005

(52) U.S. Cl. CPC B05C 17/0133; B05C 17/00576; B05C 17/00593; B05C 17/0052

(57) ABSTRACT

An improved fluid dispensing device for cooking uses is presented, comprised of a clear glass tube with a silicon ball advanced by a threaded rod. The silicon ball in the tube provides a secure seal to prevent leakage and loss of valuable oils and extracts during dispensing.

### RELATED APPLICATIONS

This application claims the benefit of U.S. Provisional Application 62/211,744, filed Aug. 29, 2015, which is included here by reference.

### FIELD OF THE INVENTION

This device is related to syringes used to dispense liquids and fluid substances. In particular, this invention is directed toward syringes with threaded rods that gradually advance and push out fluids.

### BACKGROUND OF THE INVENTION

Substances such as oils and plant extracts are difficult to dispense without residual material remaining stuck to the side of the dispenser. This increases waste and cleanup costs for the dispensing device, which may be in heavy use.

Other devices that are capable of dispensing precise amounts leave substantial amounts of waste as a consequence of the need for precision. Eyedroppers, turkey basters, and primitive syringes are classic examples of easy to clean but imprecise devices and some of the prior art devices such as U.S. Pat. No. 6,571,992 to Pierson and Metzbower are examples of precise systems with waste of residual material.

The present invention outputs small, precise amounts of material, fluids or oils, that would otherwise be rendered as waste and thereby reduces the cost of the material that Is dispensed. The unique design based on advancing a silicon ball through the syringe addresses the deficiencies of prior art devices.

### SUMMARY OF THE INVENTION

The present invention combines a food-grade silicon ball and a glass tube to form a seal that prevents oils and other fluids from seeping past the ball and causing wastage of the dispensed material. A threaded rod moves the silicon ball at a tightly-controlled rate, which provides accurate dispensing of the material.

It is an object of the present invention to provide a simply, syringe-based device to dispense precise amounts of extracts and oils.

It is a further object of the present invention to provide a syringe where the combination of a silicon ball and a screw-thread plunger rod prevents material from seeping past the mechanism as waste.

It is a further object of the invention to minimize waste and inaccurate dispensing with an easy-to-use and inexpensive to manufacture device.

### BRIEF DESCRIPTION OF THE DRAWINGS

FIG. 1 is a perspective view of the oil dispensing device.

FIG. 2 is a see-through side view of the oil dispensing device.

FIG. 3 is a cross-section view of the oil dispensing device.

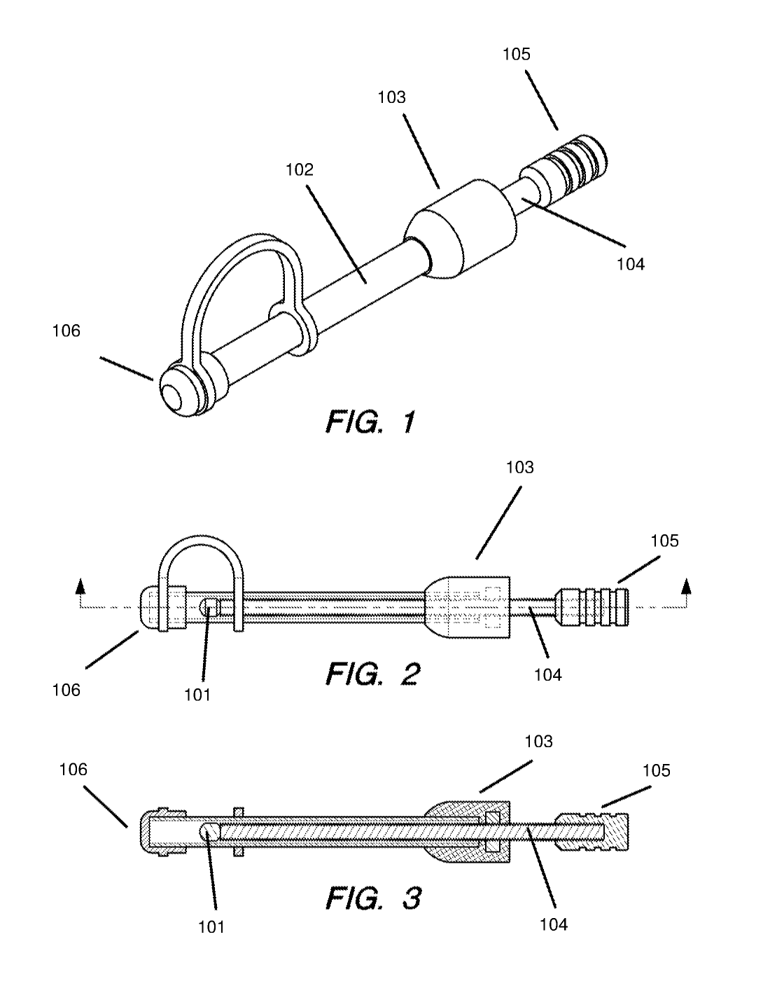

### DETAILED DESCRIPTION OF THE INVENTION

The invention is comprised of a food-grade silicon ball 101, a glass tube 102 with a threaded cap 103, a threaded rod 104 with a knob handle 105, and a silicon sealing cap 106. From FIG. 2 and FIG. 3, it can be seen that the combination of the silicon ball 101 and the threaded rod 104 makes a close seal with the walls of the glass tube 102.

The seal between the silicon ball 101 and the walls of the glass tube 102 prevents liquids from migrating back up the glass tube 102 when the liquids are dispensed. Because of the threading, the rod 104 can be advanced at a controlled rate for accurate dispensing. In comparison, prior art plunger-based dispensing systems permit large amounts of waste.

The invention is assembled by placing the threaded cap 103 at one end of the glass tube 102, the threaded cap 103 serving as a guide for the threaded rod 104 and silicon ball 101 as they are inserted into the glass tube 102. The knob handle 105 at the end of the threaded rod 104 is used to turn the rod 104 and advance the rod 104 and silicon ball 101 into and through the glass tube 102.

If the device is being used to transport liquid materials, then a silicon sealing cap 106 is attached to the glass tube 102 and the sealing cap 106 placed over the open end of the glass tube 102.

The present invention is assembled by filling the glass tube 102 at one end with oils or extracts after first attaching the silicon sealing cap 106 at the other end, inserting the silicon ball 101 at the open end, attaching the threaded cap 103 at the open end, then inserting the threaded rod 104 through the threaded cap 103 and rotate the threaded rod by means of the knob handle 105 until the silicon ball 101 contacts the oils or extracts in the glass tube 102.

The pre-loaded device can be transported or stored until used. The device is used by removing the silicon sealing cap 106 and slowly rotating the knob handle 105 to force the oils or extracts out of the glass tube 102 in a controlled manner. The device can be re-capped with the silicon sealing cap 106 and reused until the contents are exhausted.

Various modifications and alterations of the invention will become apparent to those skilled in the art without departing from the spirit and scope of the invention, which is defined by the accompanying claims.

What is claimed is:

1. A fluid-dispensing syringe device, said device comprise of a food-grade silicon ball, a transparent tube, a threaded cap, a threaded rod, a rod handle, and a sealing cap,
the transparent tube possessing two ends, the first end sealable with the sealing cap, the other end capped with the threaded cap, the threaded cap attached removably to the transparent tube,
the silicon ball sized to fit closely within the diameter of the transparent tube, the silicon ball inserted into the transparent tube through the threaded cap,
the threaded rod threaded to fit the threaded cap, the threaded cap positioned at the end of the transparent tube to guide the threaded rod,
the rod handle attached fixedly to one end of the threaded rod, the threaded rod rotated by means of the rod handle to permit the other end of the threaded rod to engage the threads inside the threaded cap,
the transparent tube comprised of glass or food grade silicon.

2. A method of assembling and using the fluid-dispensing syringe device as in claim 1, comprised of the steps of
A: assembling the device by
1) placing the sealing cap at one end of the transparent tube,
2) filling the transparent tube with oils or extracts,
3) attaching the threaded cap to the open end of the transparent tube,
4) inserting the silicon ball into the open end of the transparent tube,
5) inserting the threaded rod into the open end of the tube such that its threads engage the threaded cap,
6) advancing the threaded rod into the transparent tube by means of the rod handle until it contacts the silicon ball,
B: Then using the device by
1) removing the sealing cap,
2) positioning the fluid-dispensing syringe device appropriately,
3) advancing the threaded rod by means of rotating the rod handle,
4) observing the amount of oils or extracts that are being dispensed and adjusting the rate of rod handle rotation accordingly.
